(19) United States
(12) Patent Application Publication
(10) Pub. No.: US 2012/0191774 A1
(43) Pub. Date: Jul. 26, 2012

(54) VIRTUAL DIAL TESTING AND LIVE POLLING

(76) Inventors: Vivek Bhaskaran, Seattle, WA (US); Rudly Raphael, Chicago, IL (US); Chandika Bhandari, Redmond, WA (US)

(21) Appl. No.: 13/358,503

(22) Filed: Jan. 25, 2012

Related U.S. Application Data
(60) Provisional application No. 61/435,801, filed on Jan. 25, 2011.

(51) Int. Cl. G06F 15/16

(52) U.S. Cl. 709/203

(57) ABSTRACT

A virtual polling system allows a dial testing style of polling to occur at multiple locations and to include more respondents than a traditional dial test. In one embodiment, the system is implemented using an application component that can be run on multiple mobile or other devices and a server component that collects information from the mobile devices to provide relevant data analysis. The system provides an application that each potential respondent can run on the respondent's device of choice. The application displays a virtual dial, slider, or other user interface control that allows the respondent to indicate positive or negative sentiment, or any other response range designed by the pollster. The respondent can move the slider in real time while watching an event to indicate the respondent's impression of the event. The server component collects response information from each device and performs analysis requested by the pollster.

### CROSS-REFERENCE TO RELATED APPLICATIONS

The present application claims the benefit of U.S. Provisional Patent Application No. 61/435,801 (Attorney Docket No. SURVEY003) entitled “VIRTUAL DIAL TESTING AND LIVE POLLING”, and filed on 2011-01-25, which is hereby incorporated by reference.

### BACKGROUND

Polling is a frequent method of assessing sentiment of large populations through a small representative sample. A group is identified and asked one or more questions, or observed for behavior or reaction to events. The group may be identified based on various demographics, such as political affiliation, race, gender, age, religious views, income, marital status, and so forth. The poll content may include, for example, questions about how a group member feels about a political candidate (e.g., a political poll), observations about what television shows a group member watches (e.g., Nielsen-style television ratings), or an ongoing measure of a member's reaction to a presentation.

One type of polling is called dial testing, and refers to the use of a mechanical or electrical dial (or a virtual version of the same) that a group member can turn to indicate a positive or negative reaction. Turning the dial strongly one direction indicates strong agreement, strongly the other direction indicates strong disagreement, and positions in between each direction indicate varying gradations of agreement or disagreement. A dial test provides a real-time indication of a group member's (e.g., an audience member) response to a presentation. For example, Fox News contributor Frank Luntz often operates a dial test with a room of about 20 people during political events, where each person has a dial in front of them that they can use to indicate positive or negative reaction to what the speaker is saying. The dials of all of the members are averaged and later displayed on a screen overlaying the presentation to show an indication of how the group felt about what the speaker had to say. The indication can include a graph with separate lines for various demographics within the groups (e.g., Republicans and Democrats).

Current dial testing and other polls provide a very limited sample of people. For example, a dial test is limited to the number of people that can fit in a room equipped with dial testing equipment. The equipment is often expensive and complex to setup and monitor during the test. The test is also limited by the location of the test. For example, a dial test conducted at a television studio in New York will likely only be composed of residents of the area, and may exclude points of view such as those of a Midwest farmer or other remote person. Other polling methods include other limitations. For example, the number of operators available to make calls to potential respondents limits a phone-based poll.

### BRIEF DESCRIPTION OF THE DRAWINGS

FIG. 1 is a block diagram that illustrates components of the virtual polling system, in one embodiment.

FIG. 2 is a flow diagram that illustrates processing of the virtual polling system at a client device to deliver a virtual poll, in one embodiment.

FIG. 3 is a flow diagram that illustrates processing of the virtual polling system at a server to deliver a virtual poll, in one embodiment.

FIG. 4 is a display diagram that illustrates a mobile device running a virtual polling application, in one embodiment.

FIG. 5 is a display diagram that illustrates the mobile device of FIG. 4 after the user has selected the State of the Union poll, in one embodiment.

### DETAILED DESCRIPTION

A virtual polling system is described herein that allows a dial testing style of polling to occur at multiple locations and to include more respondents than a traditional dial test. In one embodiment, the virtual polling system is implemented using an application component that can be run on multiple (e.g., potentially millions of) mobile or other devices and a server component that collects information from the mobile devices to provide relevant data analysis. Mobile devices, such as smartphones, are nearly ubiquitous in modern developed nations such as the United States. Smartphones using the Apple iOS, Google Android, and Microsoft Windows Phone operating systems provide an application model that allows applications to be delivered to millions of devices. The virtual polling system provides an application that each potential respondent can run on the respondent's device of choice. The application displays a virtual dial, slider, or other user interface control that allows the respondent to indicate positive or negative sentiment, or any other response range designed by the pollster (e.g., agreement or disagreement). For example, a slider control may range in value from zero to 100, where zero indicates highly negative feedback from the respondent and 100 represents highly positive feedback.

The respondent can move the slider in real time while watching an event, such as a broadcast television show, to indicate the respondent's impression of the event. The server component collects response information from each device and performs analysis requested by the pollster. The server component may also provide feedback to the devices that allows one respondent to view how other respondents are reacting to the presentation. For example, a version of the virtual polling system was used in the United States during the 2011 State of the Union address by President Barack Obama, to gauge impressions of what the president said during his speech. Thus, the virtual polling system removes the limitations of prior systems by allowing a virtually unlimited number of users at any location with a network connection to provide real time polling responses.

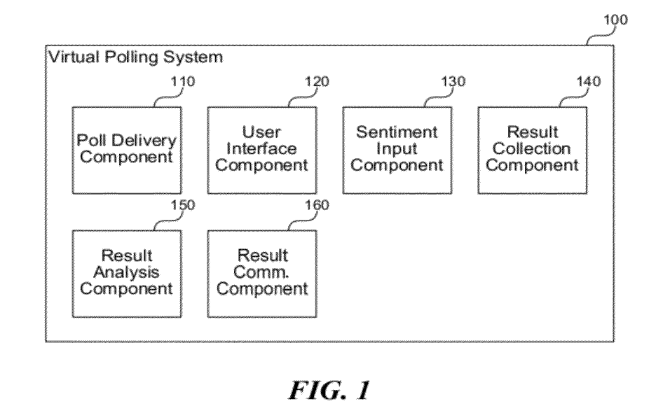

FIG. 1 is a block diagram that illustrates components of the virtual polling system, in one embodiment. The system 100 includes a poll delivery component 110, a user interface component 120, a sentiment input component 130, a result collection component 140, a result analysis component 150, and a result communication component 160. Each of these components is described in further detail herein.

The poll delivery component 110 operates at a server and responds to client requests to participate in one or more available polls. The system may provide an administrative or authoring interface through which poll authors can provide polls to be distributed to respondents through the system. The system may also provide a mobile application or other client-side software through which potential respondents can enumerate available polls and select one in which to participate. The poll delivery component 110 may provide polls through one or more standard or proprietary network protocols, such as hypertext transfer protocol (HTTP) or transmission control protocol (TCP). Once a client has selected a particular poll, the poll delivery component 110 receives a request for that poll, and the server responds with poll definition information that provides the client with information used to display appropriate user interface controls and capture appropriate information from the respondent.

The user interface component 120 operates at a client device and displays a user interface to a poll respondent. The user interface may include one or more controls, such as a dial control, slider, or other interface through which the respondent can provide answers to poll questions. The user interface may be provided through a web application (e.g., in a browser), a mobile application, a desktop application, or any other manner typically used by software. As another example, the system may provide a programmatic interface that allows other applications to integrate functionality of the system so that vendors can build custom client applications for delivering their polls to respondents. The system may also provide a generic user interface that can be skinned, themed, or otherwise modified to provide a custom look for any particular vendor or poll.

The sentiment input component 130 receives sentiment input from the poll respondent related to a selected poll in which the respondent is participating. The sentiment input may come from a dial or other control, and may include one or more values (e.g., a range from zero to 100) as defined by the particular poll definition information. As the user moves the dial or other control, the sentiment input component 130 periodically sends updated sentiment information to the server so that the server can aggregate sentiment information from multiple respondents in real time. For example, the client may send sentiment information once per second, or each time the respondent moves the control. The sentiment input component 130 may also capture other types of input, such as responses to pulse poll questions described herein, which a poll administrator can send out to respondents during an event.

The result collection component 140 collects sentiment input from multiple clients at the server. The result collection component 140 communicates with each client with an associated respondent actively participating in a poll, and dynamically aggregates responses associated with each poll. The result collection component 140 invokes the result analysis component 150 to compute information related to the collected sentiment input, such as overall average responses, average responses by demographic, and so forth. The result collection component 140 may utilize a cloud-based datacenter or other server facility for increased efficiency of communicating with client devices that are potentially spread over a large geographic area and that are potentially large in number. The collection of results from multiple distributed clients allows the system to conduct polls that are more widespread than previous polling systems.

The result analysis component 150 analyzes sentiment input collected from multiple clients to produce aggregate result data for distribution to client devices. The result analysis component 150 summarizes all of the sentiment information received to produce one or more summary datasets. For example, in a political poll, the component 150 may average all responses received from registered Democrats and all responses received from registered Republicans, so that two line graphs can be shown at each client to inform viewers how people affiliated with each party are reacting to a presentation. Poll administrators or others can determine how input related to a particular poll is analyzed and provided back to clients. The system may also store collected and analyzed poll data for subsequent reporting and analysis. Many parties purchase such information for use in campaigns or other efforts.

The result communication component 160 communicates aggregate result data to client devices during an event. For example, each client device may be uploading sentiment data to the server every second, and several seconds later the server may provide to each client aggregate data related to the last few seconds of client data. In this way, the system may be engaged in a continuous process during the event of collecting and distributing data. In some cases, collected data may be fed to a different group of people than the poll respondents. For example, poll respondents may not see aggregate data, but a campaign manager or pollster may receive a feed of collected respondent sentiment. In other cases, respondents may receive the aggregate result data. The system is flexible and can be configured on a per poll basis as to how information is collected and distributed as appropriate for any particular poll.

The computing device on which the virtual polling system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

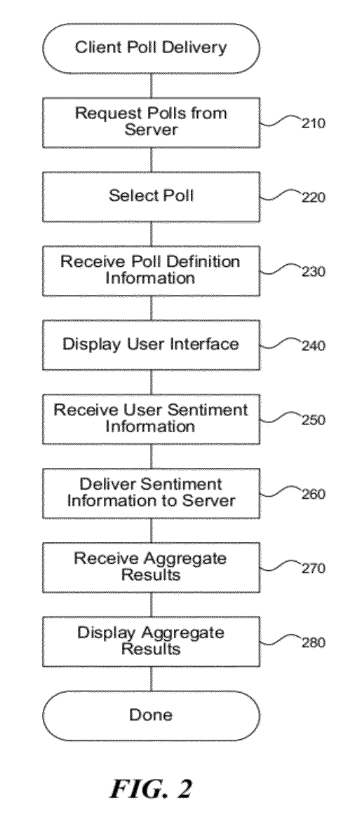

FIG. 2 is a flow diagram that illustrates processing of the virtual polling system at a client device to deliver a virtual poll, in one embodiment. Beginning in block 210, the system requests at a client device, information describing one or more polls available from a server in which a respondent using the client device can participate during a live event. For example, the server may expose an application-programming interface (API) that the client device can invoke to enumerate available polls. In some cases, the system may provide each respondent with a profile and the polls a respondent can access may depend on authentication and authorization information. For example, a particular poll may be directed to and limited to respondents of a particular demographic group. In response, the server provides a list of available polls to the client device.

Continuing in block 220, the system selects at the client device a particular poll to deliver to the respondent. The system may provide a list to the respondent and allow the respondent to select, or may provide an automated method of selecting a poll for the respondent. For example, the system may randomly select polls for respondents or may allow a particular client application to specify a specific poll that the application is designed to deliver. Following the selection, the client device sends a request for information related to the selected poll to the server.

Continuing in block 230, the system receives at the client device poll definition information that describes the selected poll. The poll definition information may describe one or more poll questions, user interface control layout (e.g., through HTML or other markup language), wizard screens, and so forth related to the poll. The client device uses the poll definition information to understand how to display the poll to the respondent. The poll definition information may also describe how frequently and under what circumstances responses provided by the respondent will be sent by the client device to the server so that the server can collect responses from multiple client devices in real time.

Continuing in block 240, the system displays a user interface at the client device that includes one or more controls for receiving sentiment information from the respondent related to the respondent's reaction to the live event. For example, the user interface may include a slider or virtual dial that the respondent can manipulate to indicate varying degrees of positive or negative sentiment in response to the live event. The user interface may also allow dynamic questions to be provided to the respondent.

Continuing in block 250, the system receives sentiment information from the respondent. As the respondent turns the dial or adjusts the slider control, the system receives input (e.g., as one or more numerical values) that can be provided to the server. Although shown serially for ease of illustration, the system performs this and the following steps on an ongoing basis during the period of a particular poll, so that sentiment information is collected and delivered to the server repeatedly throughout the poll period.

Continuing in block 260, the system delivers the received sentiment information to the server for collection and aggregation with sentiment information received from other respondents. The system may deliver sentiment information in a variety of ways depending on a manner selected for implementing the client. For example, if the client uses a web interface, then the respondent's actions in a web browser may be sent to the server via a POST or other HTTP-based mechanism to provide the sentiment information. For a client implemented as a mobile application, the mobile application may use TCP or other networking protocols to transmit sentiment information to the server.

Continuing in block 270, the system receives at the client aggregate results from the server that indicate how other respondents are reacting to the live event. The aggregate results may include a single average feed or multiple feeds broken down by demographic groups or other divisions. In some cases, the client device allows the respondent using that device to determine what aggregate information is displayed while the respondent is taking the poll, if any. In other cases, a poll administrator determines what information is displayed and instructs the client (e.g., via the poll definition information) what to display.

Continuing in block 280, the system displays the aggregate results at the client device to the respondent. The display of aggregate results is performed so that the respondent can see aggregate result information in as near real time as achievable. The information displayed to the respondent is delayed by the time it takes to collect information from each client, analyze the information at the server, and deliver the aggregate information to a particular client device. Nevertheless, the aggregate information is typically only seconds behind so that the respondent or other poll watchers can see an accurate indication of how other respondents are reacting to the live event in close to real time. After block 280, these steps conclude.

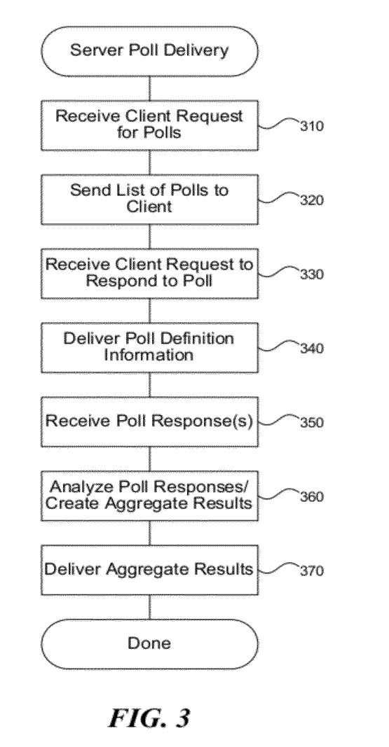

FIG. 3 is a flow diagram that illustrates processing of the virtual polling system at a server to deliver a virtual poll, in one embodiment. Beginning in block 310, the system receives at a server a client request to enumerate one or more available polls. The server provides a dynamically available poll delivery service to which clients can connect at any time to participate in a variety of live, dial testing style events. At any given time, the server may be providing multiple polls to which clients can respond. A client may be designed to deliver a specific poll or may provide a generic interface through which a respondent can select any of a variety of polls in which to participate.

Continuing in block 320, the system sends in response a list of available polls to the client. The list may include metadata, such as a poll title, numeric identifier for referring to the poll, description, information describing one or more types of desired respondents, and so forth. The process of enumerating and providing polls may occur via an HTTP request and response or other networking protocol suitable for communicating between the client and server.

Continuing in block 330, the system receives at the server a client request to participate in an identified poll. For example, the client may send a request including a numeric identifier associated with the selected poll. The server may receive many client requests as the same time, and may provide a profile for each client or respondent that tracks which polls a particular respondent has participated in, demographic information related to the respondent, and so on.

Continuing in block 340, the system delivers poll definition information for the identified poll from the server to the client. The poll definition information may include information describing user interface controls for the client to display (e.g., via a markup or other language), poll questions associated with the poll, timing information for delivering the poll, where a presentation related to the poll can be found (e.g., a uniform resource locator (URL) or other link), and so forth.

Continuing in block 350, the system receives poll response information from one or more clients. The poll response information includes dynamic sentiment information that each client provides on an ongoing basis during the period in which the poll is active. For example, the poll may be active during the course of a live presentation, and during the presentation respondents provide sentiment information that indicates how each respondent is reacting to the presentation (e.g., favorably or unfavorably). The server collects this information from each client to provide aggregate results during and at the end of the poll.

Continuing in block 360, the system analyzes received poll responses at the server to create aggregate poll response information. The aggregate poll response information may include an average of all of the receive responses, averages of responses from various demographic groups, averages of respondents in particular locations, and so on. The system may attempt to quickly determine the aggregate results so that the results can be provided to respondents or other interested parties in near real time.

Continuing in block 370, the system sends the aggregate poll response information to one or more interested parties. In some cases, the interested parties are the respondents that are taking the poll. In other cases, the interested parties may include those associated with a political campaign, event producers, or others that are interested in how well the live event is received by viewers. In addition to aggregate information provided during the live event, the system may also provide a variety of reports after the event that include collected information. After block 370, these steps conclude.

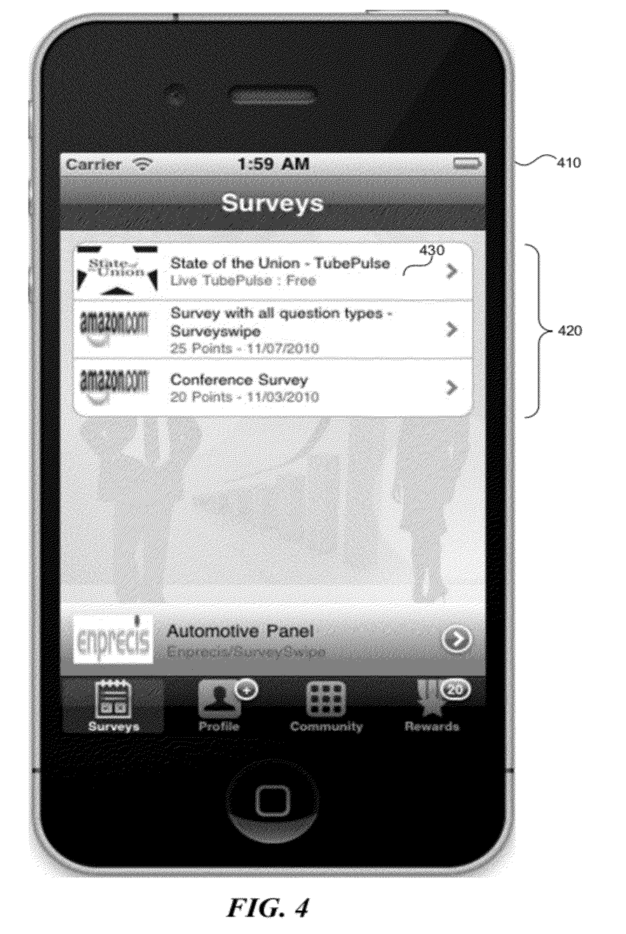

FIG. 4 is a display diagram that illustrates a mobile device running a virtual polling application, in one embodiment. The illustrated interface 410 provides a list 420 of available polls to the user of the application, from which the user can select a poll in which to participate. The top poll 430 is a live dial testing survey that allows the user to participate in dial testing for the State of the Union address.

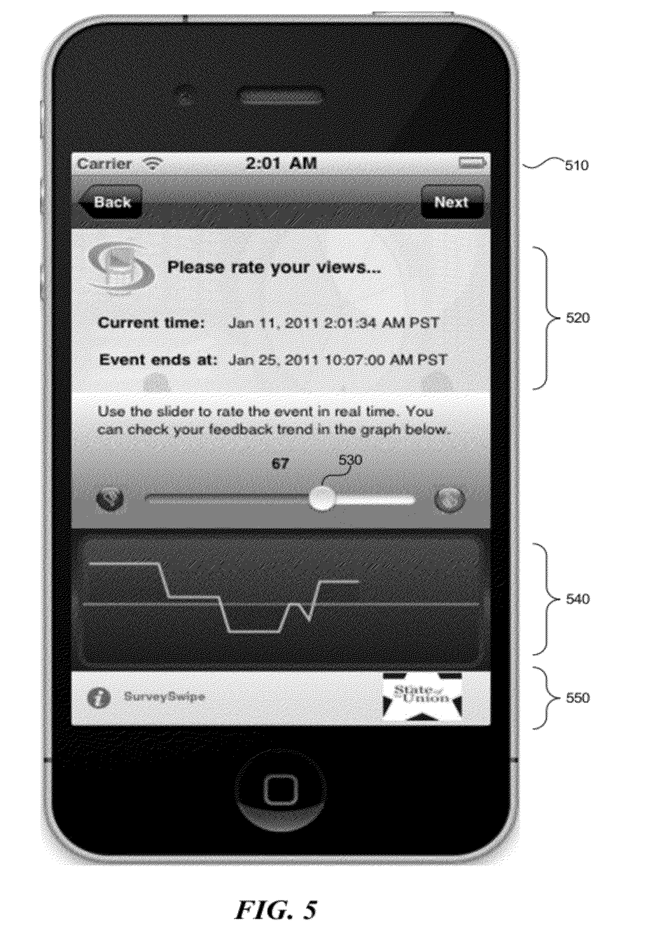

FIG. 5 is a display diagram that illustrates the mobile device of FIG. 4 after the user has selected the State of the Union poll, in one embodiment. Moving from top to bottom, the display 510 includes information 520 about the timing of the event, a slider control 530 for the user to indicate feedback about the event in real time, a graphical display 540 of responses from other users, and branding information 550 that a poll designer can use to customize the poll. The slider control 530 allows the user to move an indicator from left to right, where the far left indicates negative feedback and the far right indicates positive feedback. By touching the screen or using other input, the user can move the indicator during a separately displayed presentation to indicate the user's feedback about what is happening during the presentation. In some embodiments, the application may provide an integrated display of the presentation, such as a video window. The graphical display 540 of other users' responses provides an average of how other users have positioned their own slider controls. In some embodiments, the user can slide the graph left or right to view other graphs, such as those that filter the data based on particular demographics.

In some embodiments, the virtual polling system allows a pollster to inject questions on the fly to users of the application to conduct a pulse poll. For example, if a political speaker mentions the topic of immigration during a presentation, the pollster can send a question to each respondent asking how he or she feels about a border fence. The application may provide a pop up dialog box or may display in a region of the screen that does not interfere with ongoing dial testing, and then upload the respondent's response to the server for collection and analysis.

In some embodiments, the virtual polling system provides a bidirectional experience not available in previous dial testing systems. While each respondent is providing information that the virtual polling system uploads to a server for collection and analysis, the server may also provide information that flows down to each device, such as summary information about how other respondents are reacting. For example, the application running on each respondent's device may include a displayed graph above or below the input control through which the respondent provides his or her own response. The displayed graph may illustrate to the respondent an average of other respondents' input. The display may also allow the respondent to adjust the displayed information about certain demographic groups. For example, if the respondent is affiliated with one political party, he or she may want to view how respondents of the opposing party react to the presentation.

In some embodiments, the virtual polling system receives demographic information from each poll respondent before the event. For example, the application described herein may capture profile information from the respondent, such as age, gender, race, political party, income level, and so forth. The application may also capture information from the device, such as the device's location (e.g., via a global positioning system (GPS) chip or triangulation using Wi-Fi or cellular towers). The application can upload the demographic information to a server for storage and can provide the demographic information in association with survey and dial testing responses. This provides useful context information about the data received at the server and allows the server to perform data analysis based on demographic information.

In some embodiments, the virtual polling system provides a backend or administrative interface through which pollsters can receive additional reporting information derived from incoming collected data. For example, the system may provide breakdowns of polling information that are not made available to respondents. The system may also provide a subscription or premium service, through which pollsters or other users can pay an additional fee to view more in depth information. For example, the system may provide results broken down by city in which respondents are located, political party, age, income level, and so forth.

In some embodiments, the virtual polling system provides rolled up information at the end of an event. For example, after a political speech or other presentation, the system may provide information about the number and types of respondents that participated in real-time dial testing or other polling (e.g., pulse polls described herein), overall impressions of the event (e.g., 60% positive rating), and so forth. The value of polling for the pollster is in the sophistication of the reports that can be derived from the collected data, and the virtual polling system allows pollsters to extract information about the collected data in a variety of ways.

In some embodiments, the virtual polling system provides a website that allows pollsters and/or respondents to view incoming data in near real-time. For example, devices running the polling application may upload data on a periodic interval (e.g., every 500 milliseconds) to a server that collects the data. The website accesses data collected by the server to display information about responses, such as graphs optionally filtered based on demographic information.

In some embodiments, the virtual polling system can be used during entertainment events to capture viewer information. For example, a reality show can use the system to capture very interactive feedback from viewers of the show. The information may include the respondent's level of interest (e.g., from bored to highly entertained) at each moment during the show, the respondent's opinion of each participant in the show, who should be voted off in shows that eliminate participants, and so forth.

In some embodiments, the virtual polling system collects and provides structured polling data about events. Unlike unstructured data collection methods such as analyzing tweets or text messages to assess what people are saying about an event, the virtual polling system can collect very sophisticated and structured information. For example, the system captures demographic information about each respondent so that opinions have more value than those from anonymous respondents. The system can also control the questions asked and information collected to focus the respondents on particular topics or issues for which a pollster wants information.

In some embodiments, the virtual polling system provides links to structured polling data reported about events. Not only can a pollster slice the collected data in a variety of ways, but the system also provides the pollster with an automatically generated link for sharing the results of the pollster's review of the data with others. For example, a pollster that identifies an interesting trend in a particular demographic of respondents can provide a link on the pollster's blog through which interested parties can view graphs and other forms of the data themselves.

Any size organization—a blog publication, a small town, or a large government can introduce real-time polling for events such as the State of the Union. The virtual polling system allows polling organizations to poll their audience in real time, as users are watching the event—using a mobile or other application. In some embodiments, the system combines this information with text analytics research tools (e.g., the 10-year NSF-funded text analytics research tool DiscoverText™) that analyze the data from social networks or other sources. The explosive growth of smart phones, coupled with their inherent location-based underpinnings makes these devices a useful platform to collect real-time, participatory feedback during events. The virtual polling system provides a huge opportunity to engage with constituents of various organizations in previously difficult or unavailable ways.

In some embodiments, the virtual polling system allows each organization to create its own traffic and data set. For example, an organization can use a custom URL, such as “http://sotu.micropanel.com/?custom1=YOUR_DOMAIN_NAME”, where YOUR_DOMAIN_NAME is replaced with a domain name of the organization. This allows the system to track users using each organization's URL. After the event, the system can share and compare data sets based on organization.

In some embodiments, participating communities (partners) can be recruited to ask their members sign up for the event by downloading a free mobile application. During the event, partners interface with members via a web based administrative dashboard where they can pulse (push notify) questions to their members, either planned or on the fly. There is also the ability to pre and post survey members. The application tracks answers, which can be analyzed via online analytics software. Partners get membership data and the analytics can be provided free or for payment.

In some embodiments, the system provides the ability for partners to brand the application. For example, those partners that recruit a threshold number of respondents (e.g., 10,000) may be offered branding opportunities or other rewards, such as discounts on future polling projects.

From the foregoing, it will be appreciated that specific embodiments of the virtual polling system have been described herein for purposes of illustration, but that various modifications may be made without deviating from the spirit and scope of the invention. Accordingly, the invention is not limited except as by the appended claims.

I/We claim:

1. A computer-implemented method to deliver a virtual poll at a client computing device, the method comprising:
requesting at the client device information describing one or more polls available from a server in which a respondent using the client device can participate during a live event;
selecting at the client device a particular poll to deliver to the respondent;
receiving at the client device poll definition information that describes the selected poll;
displaying a user interface at the client device that includes one or more controls for receiving sentiment information from the respondent related to the respondent's reaction to the live event;
receiving sentiment information from the respondent;
delivering the received sentiment information to the server for collection and aggregation with sentiment information received from other respondents;
receiving at the client aggregate results from the server that indicate how other respondents are reacting to the live event; and
displaying the aggregate results at the client device to the respondent,
wherein the preceding steps are performed by at least one processor.

2. The method of claim 1 wherein requesting information describing one or more polls comprises invoking an application programming interface (API) of the server that the client device can invoke to enumerate available polls.

3. The method of claim 1 wherein requesting information describing one or more polls comprises logging into a respondent profile maintained by the server to identify polls a respondent can access based on authentication and authorization information.

4. The method of claim 1 wherein selecting a particular poll comprises providing a list to the respondent and allowing the respondent to select from the list.

5. The method of claim 1 wherein selecting a particular poll comprises automatically selecting a poll for the respondent and sending a request for information related to the selected poll to the server.

6. The method of claim 1 wherein receiving poll definition information comprises receiving information describing one or more poll questions.

7. The method of claim 1 wherein receiving poll definition information comprises receiving information describing user interface control layout for displaying the poll to a respondent.

8. The method of claim 1 wherein receiving poll definition information comprises receiving information describing how frequently and under what circumstances responses provided by the respondent will be sent by the client device to the server so that the server can collect responses from multiple client devices in real time.

9. The method of claim 1 wherein displaying the user interface comprises displaying a slider or virtual dial that the respondent can manipulate to indicate varying degrees of positive or negative sentiment in response to the live event.

10. The method of claim 1 wherein receiving sentiment information comprises receiving sentiment information on an ongoing basis during the period of a particular poll, so that sentiment information is collected and delivered to the server repeatedly throughout the poll period.

11. The method of claim 1 wherein receiving aggregate results comprises receiving a single average feed of other respondents' input or multiple feeds broken down by demographic groups or other divisions.

12. The method of claim 1 wherein receiving aggregate results comprises allowing the respondent to determine what aggregate information is displayed while the respondent is taking the poll.

13. A computer system for virtual dial testing and live polling, the system comprising:
a processor and memory configured to execute software instructions embodied within the following components;
a poll delivery component that operates at a server and responds to client requests to participate in one or more available polls;
a user interface component that operates at a client device and displays a user interface to a poll respondent;
a sentiment input component that receives sentiment input from the poll respondent related to a selected poll in which the respondent is participating;
a result collection component that collects sentiment input from multiple clients at the server;
a result analysis component that analyzes sentiment input collected from multiple clients to produce aggregate result data for distribution to client devices; and
a result communication component that communicates aggregate result data to client devices during an event.

14. The system of claim 13 wherein the poll delivery component provides an administrative authoring interface through which poll authors can provide polls to be distributed to respondents through the system.

15. The system of claim 13 wherein the poll delivery component provides a mobile application through which potential respondents can enumerate available polls and select one in which to participate.

16. The system of claim 13 wherein the sentiment input component receives input from a virtual dial or slider similar to traditional dial testing interfaces, such that as the respondent moves the dial or slider, the sentiment input component periodically sends updated sentiment information to the server so that the server can aggregate sentiment information from multiple respondents in real time.

17. The system of claim 13 wherein the result collection component communicates with each client with an associated respondent actively participating in a poll, and dynamically aggregates responses associated with each poll.

18. The system of claim 13 wherein the result analysis component summarizes sentiment information received from each client to produce one or more summary datasets.

19. A computer-readable storage medium comprising instructions for controlling a computer system to deliver a virtual poll from a server, wherein the instructions, upon execution, cause a processor to perform actions comprising:
receiving at a server a client request to enumerate one or more available polls;
sending in response to the request a list of available polls to the client;
receiving at the server a client request to participate in an identified poll;
delivering poll definition information for the identified poll from the server to the client;
receiving poll response information from one or more clients;
analyzing received poll responses at the server to create aggregate poll response information; and
sending the aggregate poll response information to one or more interested parties.

20. The medium of claim 19 further comprising, during a poll, sending a dynamic poll question from the server to one or more clients to gather dynamic feedback from the respondents.
